(19) United States
(12) Patent Application Publication
(10) Pub. No.: US 2017/0116886 A1
(43) Pub. Date: Apr. 27, 2017

(54) METHOD AND SYSTEM FOR TRAINING WITH FREQUENCY MODULATED SOUNDS TO ENHANCE HEARING

(71) Applicant: REGENTS OF THE UNIVERSITY OF CALIFORNIA, Oakland, CA (US)

(72) Inventors: Aaron Seitz, Riverside, CA (US); Victor Zordan, Riverside, CA (US); Frederick Gallun, Portland, CA (US)

(73) Assignee: REGENTS OF THE UNIVERSITY OF CALIFORNIA, Oakland, CA (US)

(21) Appl. No.: 15/332,845

(22) Filed: Oct. 24, 2016

Related U.S. Application Data
(60) Provisional application No. 62/245,599, filed on Oct. 23, 2015.

(51) Int. Cl. G09B 21/00; G09B 5/04

(52) U.S. Cl. CPC G09B 21/009; G09B 5/04

(57) ABSTRACT

A system and method is disclosed to enhance hearing employing a set of stimuli that collectively form a basis set for an auditory process comprising running a game engine on a processor of a server. Game mechanics are provided for a game, providing interaction between a player and the game. Game aesthetics and game progression are further provided. One or more learning modules stored in a database on the server are selected, the one or more learning modules comprising auditory training procedures, and are used within the game engine for auditory training of the player.

### CROSS-REFERENCE TO RELATED APPLICATIONS

This Application claims the benefit of U.S. Provisional Patent Application No. 62/245,599, titled “Method and System for Training With Frequency Modulated Sounds to Enhance Hearing”, filed Oct. 23, 2015, the contents of which are incorporated herein by reference in their entirety.

### FIELD OF THE INVENTION

The invention relates to a method and system for training with a basis set of frequency modulated sounds to enhance hearing. Specifically, the invention provides systems and methods based upon contemporary knowledge of auditory neuroscience and instantiated in brain training games to train hearing improvements in individuals.

### BACKGROUND

Hearing is a fundamental perceptual ability that profoundly impacts our lives. Our ability to understand speech, appreciate music, and understand the goings-on in the environment depends critically upon hearing. Hearing loss is a common impairment occurring from disease, traumatic brain injury, noise exposure, and normal aging and has numerous negative effects to people's lives. However, while there are approaches that address peripheral causes of hearing loss (for example, hearing aids and cochlear implants), solutions to hearing loss related to central auditory processing are very limited.

Mental fitness, despite its critical value for the success and well-being of individuals and the larger society, has received less systematic attention than physical fitness. Unlike physical training, there exists no universally accepted scientific methodology to systematically promote mental fitness in either cognitively impaired or normally functioning individuals. However, recent advancements in auditory neuroscience, perceptual learning and video game technologies offer promise to achieve procedures that will improve hearing. 1) Studies of auditory neuroscience and psychoacoustics have advanced our understanding of the functioning of neurons involved in central auditory processing—in particular, how frequency modulated sounds form a basis function of audition; 2) Modern computing technologies have led to enormous innovations in entertainment software and hardware, and are poised to have transformative impact on cognitive health; 3) Studies of perceptual learning have advanced our understanding of plasticity in the neural systems underlying hearing, and have refined behavioral procedures that engage these systems; 4) Commercial video games have become ubiquitous, sophisticated, and shaped by competitive market pressures to become both perceptually engaging (rich graphics, sounds, and animations), and cognitively challenging.

While there exist some contemporary approaches devised to improve hearing in a variety of populations, these are largely based upon emulating hearing scenarios in the environment. For example, it is common to train people with speech sounds in different levels of noise, or to have people practice understanding easy sentences and then progressing to more difficult sentences. In fact, some approaches do use narrow-band FM sweeps to train individuals to identify them when played more quickly.

In order to solve the shortcomings of the prior art, novel systems and methods herein provide procedures based upon contemporary knowledge of auditory neuroscience and instantiated in brain training games to train for hearing improvements in individuals by combining the elements of computing, cognitive science, and video game design to lead to behavioral cognitive therapies that are effective, encourage compliance by being compelling, stimulating and fun.

### SUMMARY OF THE INVENTION

In order to solve the shortcomings of the prior art, methods and systems described herein:

1) Use sounds that are based upon those which have been used to successfully characterize basis functions in auditory cortex (such as ripples) or those underlying speech sounds (formants) and to train the full set of sounds from which speech (and other environmental sounds) are built upon;

2) Target improving hearing through coordinated multi-modal methods. The strength of incorporating multisensory objects into hearing training is that each sense can boost learning in the other. For example, an individual with limited hearing capabilities will benefit from training utilizing concordant visual stimuli. For example, in a game, players with hearing impairments can learn the tasks based upon the visual stimuli, and as these are degraded, players will naturally start relying upon the auditory stimuli. Along this line, research demonstrates that objects that are simultaneously represented by multiple modalities are better remembered, and that coordinated training with multiple modalities better supports sensory representations of those stimuli. Furthermore, research shows that training on a diversity of stimuli (e.g. multiple frequencies and types of FM sounds, within and without noise, in combination with other environmental sounds such as speech, etc.) can aid with generalization. These can be combined with other approaches, such as stimulus ordering, and how attention and reinforcement are directed during the task, and how the task-difficulty is adaptively determined for each subject, to further better learning;

3) Use advanced principles from modern video game design, incorporating engaging video game design as an aspect of bridging the gap between commercial games and cognitive training. The practices of good video game design are becoming better understood and documented. As the field matures, design rules and constraints are refined and accepted. For example, games establish clear goals and allow players to realize those goals through meaningful actions. Successful design has critical aspects that make games engaging, including its mechanics, its interaction, and so on. By isolating and refining each of these, the game design process moves from a “black box” to one that is observable, trackable, and iterative. These include:

Principle a) Game Mechanics, the core rules of games that dictate how players enact change to achieve the necessary steps to progress, make or break games by acting as the foundation for gameplay. Mechanics are the main tool for building a desirable, fun activity for users. If they are faulty, little can be done to make a player enjoy their game-playing experience.

Principle b) Interaction, the hardware and software elements between players and games enables players to engage, interact and communicate. Good interaction often is intuitive and builds upon players' prior experience to facilitate meaning and action, and provides feedback conveying undeniable evidence that players' actions are understood.

Principle c) Visual/Sensory Experience is an important aspect of any game, as aesthetics have a profound impact on the engagement of the audience. Players enjoy interacting with pleasing and/or provocative sensory experience. A rich and engaging environment for the game, including its soundscape, is a factor that determines whether players will continue to play, or to find something else to do.

Principle d) Progression of games must temper the challenges to meet players' changing skill levels. Progression, often in the form of game levels, ensures games are cast within the range of player skills. As players become more proficient in achieving established goals, game difficulty may increase to maintain interest. Progression plays a major role in the framework described herein. Its influence is two-fold, both to keep engagement, promoting treatment compliance, but also to grow appropriately as to promote maximal benefit into mental fitness.

Disclosed is a novel approach to improve hearing through procedures that exercise auditory cortical function. This is through a novel combination of frequency modulated sounds that are modeled after auditory neuron receptive field properties (ripples) and human speech sounds (formants) in perceptual learning procedures in which adaptive procedures and coordination of information across modalities (either simultaneously or in sequence) are designed to unlock plasticity with the auditory system and to improve hearing processes. These are combined with interaural localization cues (e.g. interaural time difference and frequencies differences or head related transfer functions) to also train sound source segregation. In this approach, sound types are chosen that span the range of frequency modulations that humans are sensitive to, and as such are training across an auditory basis function. This auditory basis function can consist of narrow and broadband changes of sound frequency over time in which parameters (such as duration, rate of frequency change, amplitude, base frequency, bandwidth, and signal to noise) are adaptively manipulated to generate challenges to participants. In some instantiations, video game frameworks are also applied to enhance participant motivation and compliance with the training procedures. The advantage is that specific knowledge of neuroscience and psychophysics of human hearing processes are combined with approaches that maximize brain plasticity and video game approaches that enhance motivation and program compliance to achieve training systems that are well-principled, effective and that individuals want to train with. The disadvantage of previous approaches is that they don't train on an auditory basis function (instead there is a less complete sampling of sound types), do not take advantage of perceptual learning principles (such as multisensory facilitation) and do not integrate advanced gaming principles to make games that people want to play for the sake of the games (thus have problems with compliance). Procedures described herein address each of these limitations to aid auditory processes as they are engaged typical real-world contexts.

### BRIEF DESCRIPTION OF THE DRAWINGS

These and other features, aspects and advantages of the present invention will become better understood with regard to the following description, appended claims, and accompanying drawings where:

FIG. 1 is a diagrammatic representation of an exemplary internet-based environment in which one embodiment may operate;

FIG. 2 is a diagrammatic representation of the components of one or more of the portable or stationary user devices according to the embodiment of FIG. 1;

FIG. 3 is a diagrammatic representation of the components of a server device according to the embodiment of FIG. 1;

FIG. 4 is a diagrammatic representation of the server device of FIGS. 1 and 3, and a storage device with a database containing electronic data that is transformed;

FIG. 5 is a diagram of a multi-modal system to improve hearing using a video game, according to one embodiment;

FIG. 6 is a diagram of some of the types of perceptual learning modules that can be combined to create more effective auditory training procedures;

FIG. 7 is a block diagram illustrating some elements of game design according to one embodiment;

FIG. 8 is a spectrogram (time vs frequency plot) of the words lock and rock according to one embodiment; and

FIG. 9 is a spectrogram (time vs frequency plot) of different narrow band ripples, notched-noise and ripples in noise, according to one embodiment.

### DETAILED DESCRIPTION

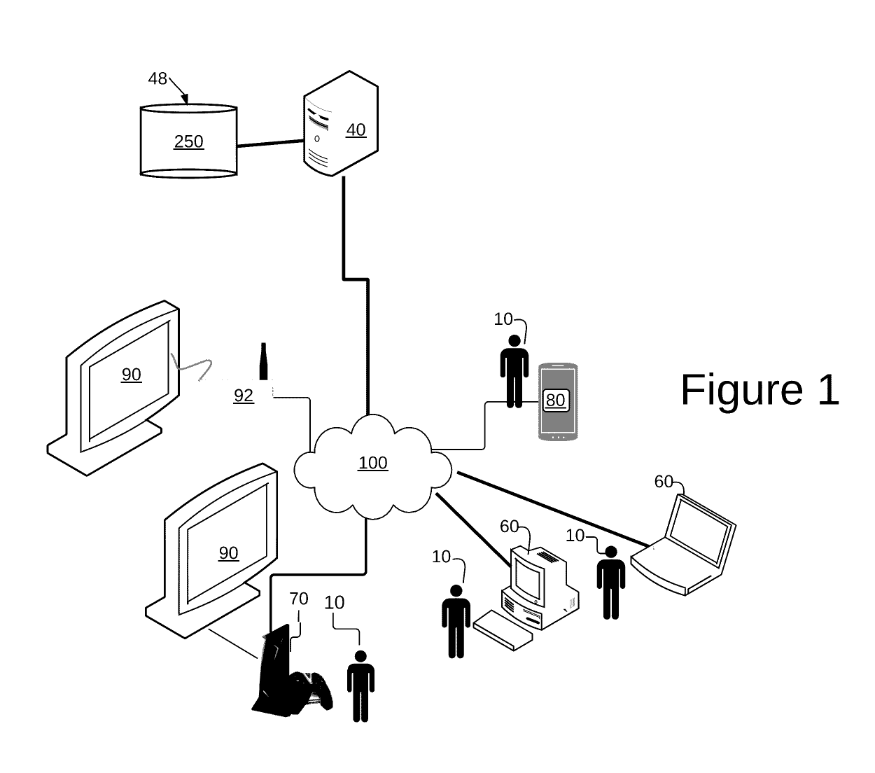

For illustrative purposes, the present invention is embodied in the apparatus and method generally shown and described herein with reference to FIG. 1 through FIG. 9. It will be appreciated that the apparatus may vary as to configuration and as to details of the parts, and that the method may vary as to the specific steps and sequence, without departing from the basic concepts as disclosed herein.

The present invention overcomes the limitations of the prior art by providing a system and method to improve hearing via at least three distinct elements, either individually or in combination:
1) Uses sounds that are based upon those which have been used to successfully characterize basis functions in auditory cortex. A given basis set is considered one that spans frequencies 250-4000 hz with upward and downward changes in frequency directions. Using a full set of frequencies of different modulation types (up, down, and combinations of such) at different frequency bands and bandwidths, and different spectral characteristics (e.g. ripples, formants, and sweeps), in isolation, in combination, as such, to broadly exercise the population of neurons in auditory cortex and to train the full set of sounds from which speech (and other environmental sounds) are built upon. These sounds can be played at different durations, with different bandwidths, in different noise contexts and in combination with other sound-types (such as combined with speech in noise training), sound localization cues (interaural time and level differences and head related transfer functions), and in different task contexts (detection, discrimination, localization, identification, etc.).
2) Adopts a multimodal training system. In this context, modalities are broadly defined to include (but not to be limited to) the following forms:
   i) Sensory modalities—signal/stimuli defined by sensory features such as (but not limited to) color, texture, shape, faces, location, context, movement, sound, music, haptics, etc.
   ii) Action modalities—within the game, actions convey the player, which include (but are not limited to) grab, target, move, jump, avoid, etc.
   iii) Task modalities—the brain training may be coordinated across tasks including (but not limited to) detection, discrimination, localization, identification, crossmodal matching, memory matching, and the like. As an example, the system can employ: multi-modal stimuli—defined by multiple features, such as sound plus shape, sound plus color, shape plus color and sound, sound plus motion and/or location, etc.; combinations of modalities as features for targets with other features as distractors; and/or tasks that engage users under multiple different contexts (for example, detection, discrimination, localization, identification, crossmodal matching, memory matching, memory association, object recognition and search tasks, etc.). The novelty of the approach is to employ such modalities in a coordinated manner. That is, the game may employ hearing training through the excitement of such modalities (as defined above) appearing in contemplated, purposeful pairings of two or more modalities, either appearing simultaneously or in series. Extended examples describe exemplary coordinations for clarification subsequently.
3) Adopts game design principles to create tasks that are fun to use and challenging to participants as their hearing skills develop. The advantage of the video game approach is that such systems engage cognitive processes while entertaining participants, which simultaneously improves both compliance and training.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure wherein the element first appears.

As used in this disclosure, except wherein the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, wherein the interface is the point of interaction with software, or computer hardware, or with peripheral devices.

Various embodiments provide a multi-modal method to improve human memory using a video game. The method will now be disclosed in detail.

### Example Instantiations

It should be noted that the specific embodiments disclosed herein are meant to be exemplary, and that other repetition-based auditory training using stimuli with multiple stimulus sets may be used as desired, including in combination. In other words, the exercises described herein are but specific examples of hearing training games. The examples each use a computing system to present stimuli to a participant. Through the participant's responses, they modify some aspect of the stimuli. Method elements are repeated in an iterative manner to the end of improving the participant's ability to process information. Note particularly that such training using a variety of exercises, possibly in a coordinated manner, is contemplated. Those skilled in the art should appreciate that they can readily use the disclosed system and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media. The disclosure is illustrated in the following examples, which are provided by way of illustration and are not intended to be limiting.

### Basic Sound Training on FM Stimuli

In a first insanitation, a hearing training task can be created where a set of sweeps, formants and/or ripples are chosen that collectively span frequency ranges 250-4000 hz and that vary in the direction of frequency modulation (up and down). The player's task is to report whether the sound modulation is upwards or downwards in frequency. Adaptive procedures are run for each frequency on sound duration, slope of frequency change, and/or signal to noise ratio of the sound. Multiple sessions of training may be conducted with progress adaptively tracked across sessions.

### Basic Sound Training on FM Stimuli+Localization Cues

In a second insanitation, procedures are the same as above. However, in some trials, users must also detect the location of the sounds to provide correct responses. In these trials interaural time and/or level differences are employed (in one embodiment, in conjunction with more sophisticated location cues such as using head related transfer functions) that simulate sound stimuli to be originating from different locations. The saliency of these localization cues are adaptively varied based upon user responses to train users to segregate one or more sound sources and to report the location of the target sound.

### Sound Training on FM Stimuli+Visual Stimuli

In a third instantiation, a hearing training task can be created where each task-item is defined by two or more modalities. For example, these can be shape and sound, color and sound, shape and color and sound, texture and sound, motion type and sound, or in general any combination of features (color, texture, shape, faces, location, context, movement, sound, haptics, etc.) such that these task-items are defined by the collection of features. In a given trial the presence and/or salience of the non-target-sound features can be varied to make the task easier or harder to perform. In this way the non-target-sound features facilitate processing of the target-sound features and enhance the learning process.

### Sound Training on FM Stimuli+Game

In a fourth instantiation, the task may be presented in a game, for example, in which target sounds are relied upon to perform well in that game. For example, in the context of a continuous runner game, upward and downward changes in frequency can be associated with jumping over, and ducking under, obstacles, respectively. Likewise, localization cues can indicate leftward and rightward turns along the path. Game play may be adaptive so that as players who perform well at a given sound-difficulty, are then presented a more difficult sound-set. Visual stimuli can be added, and degraded, to achieve multisensory facilitation. Other game elements may be augmented (e.g. speed, navigational challenge, etc.) to enhance challenge of, and thus user experience in, the game.

### Sound Training on FM Stimuli and Speech Sound

In a fifth instantiation, training on FM stimuli can be combined with training speech stimuli (formants, phonemes, vocoded or synthesized speech, and/or real speech, etc.). This can be in, or out, of the context of the game. Similar adaptive procedures can be employed in varying the difficulty of the native speech, adding noise to the speech, using vocoded speech, and the like. This may or may not be in combination with the above-described methods. For example in the game, speech sounds can indicate appropriate actions of the players and difficulty of comprehension can determine difficulty of play. These can be within the same game or across multiple games that are complementary attributes. Combined training is expected to yield gains above and beyond that of training just on FM stimuli.

### System Structure

With reference to FIG. 1, a diagrammatic representation of an exemplary internet-based system is shown in which the system and method may operate according to one embodiment. As is typical on today's internet 100, users 10 may connect to and use the internet 100 over several platforms. Those platforms may include personal computers 60, mobile phones or tablets 80, or the like. One of the latest ways to connect to the internet includes using internet protocol television, or IPTV, boxes 92. These IPTV boxes 92 include a wireless or wired device that has a memory and storage for applications or apps that connects to the internet 100. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Over and above the mobile phones and tablets 80, computers 60, and the like, discussed above, other popular devices, such as modern game consoles 70, are now capable of video play. Game consoles 70 such as the XBOX®, Playstation®, Nintendo®, Wii®, and others, provide for internet video presentation. Just as with the IPTV box 92, game consoles 70 typically connect to a TV 90 on which videos may be viewed and games played. Virtual reality systems, such as those branded as, or available from, Oculus®, HTC®, VIVE®, Microsoft Hololens, may also be used.

One or more servers 40 may include one or more storage devices 48 containing one or more databases 250.

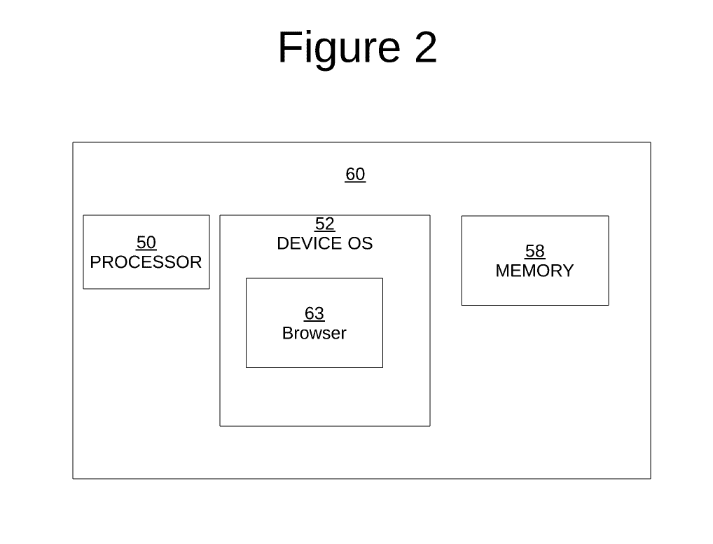

With reference to FIG. 2, a diagrammatic representation of the internal components of one or more of the user devices 60 (92, 70, 80 in FIG. 1) is shown. As those skilled in the art would recognize, each user device 60, 92, 70, 80 may include a processor 50 and operating system 52, on which executable instructions of a browser app 63 may execute. As those skilled in the art would recognize, the browser app 63 is available for internet browsing. Further, the user devices 60, 92, 70, 80 may each have a random access memory (RAM) 58 that may be used for running browser app 63, loading programs, and storing program variable data.

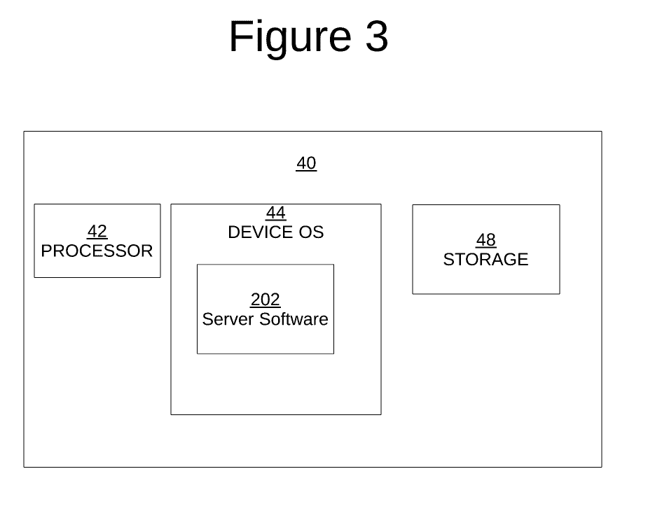

With reference to FIG. 3, a diagrammatic representation of the internal components of the server device 40 of FIG. 1 is shown. As those skilled in the art would recognize, the server device 40 may include a processor 42 and server operating system 44, on which executable instructions of a game engine software 202 may execute. As those skilled in the art would recognize, the computer program, which may embody game engine software 202, may be loaded by an operating system 44 for running on the server 40.

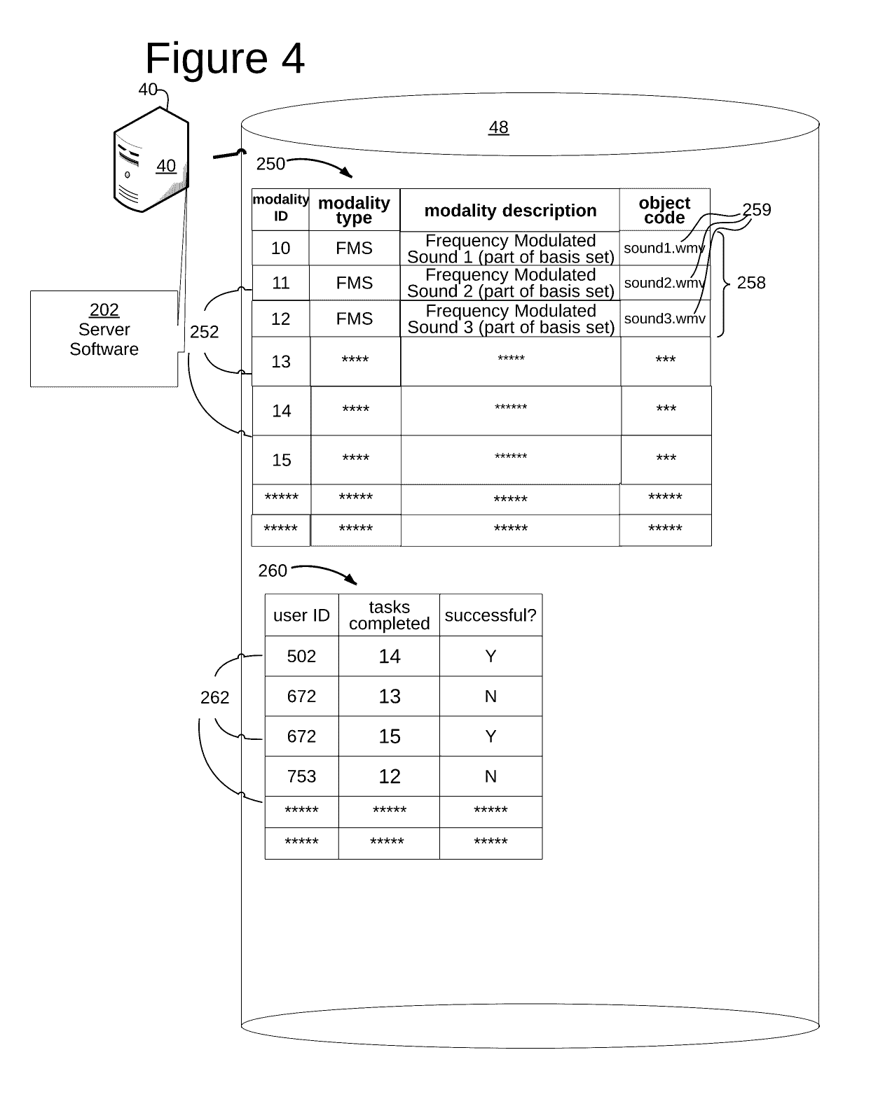

With reference to FIG. 4, a diagrammatic representation of the one or more servers 40, and a storage device 48, is shown. As indicated above, the server 40 may have executing within it game engine software 202. The game engine software 202 may comprise instructions to run online games played by users 10. The storage device 48 may store one or more databases to manage or control play of the online games. An exemplary database table 250 is shown in FIG. 4 illustrating some of the electronic data that may be stored and transformed to manage game play. For example, each record 252 of table 250 may contain content assets for game play described below. Each record 252 may contain a field for modality identifier (ID), a field for the type of modality, and a description field. Further, an executable object code field may contain the object code or link libraries to execute each module that the game engine software may call upon to execute during game play.

In one embodiment, the database 250 may contain a set of records 252 that may contain basis set records 258. Each of those basis set records 258 may contain object code comprising a set of auditory stimuli to form a basis set 259 of an auditory process that collectively span a relevant part of auditory feature space related to that process. In one embodiment, the basis set may be stored in the form of sound files 259 in, or pointed to by, the database 250.

Another table 260 may contain user data. For example, records in table 262 may contain user play data, including fields for the user identifier (ID), game tasks completed, and whether each task the user played was successful or unsuccessful.

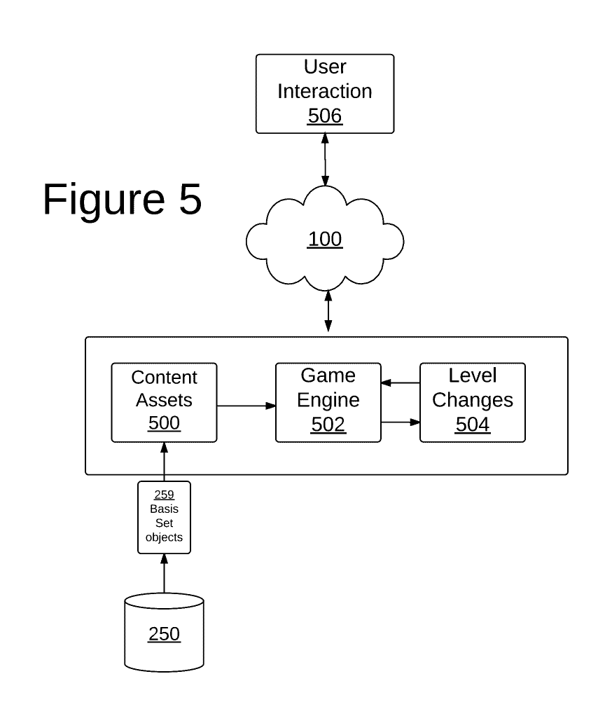

Referring now to FIG. 5, there is shown a flow diagram for multi-modal embodiment to improve hearing executed by the game engine software 202, according to one embodiment. The game engine software 202 comprises modules for reading content assets, step 500, for operating the game engine software 202, step 502, to run level changes 504 and provide user interface for interaction, step 506 through the network 100. The system may incorporate engaging video game design as an aspect of bridging the gap between commercial games and hearing sensory training. The practices of good video game design are becoming better understood and documented.

From the database 250, the basis set 259 may be incorporated into the content assets step 500 to feed into the game engine 202 in step 502 to be used during game play.

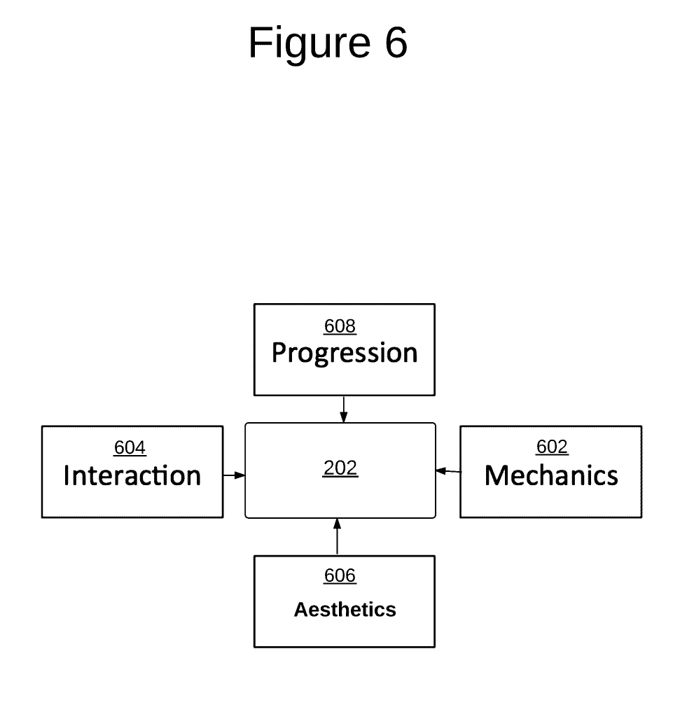

With reference to FIG. 6, a block diagram illustrating some elements of game design according to one embodiment is shown. As the field matures, design rules and constraints are refined and accepted. For example, games establish clear goals and allow players to realize those goals through meaningful actions. In one embodiment, aspects that make games run on the game engine 202 to be engaging include mechanics, interaction, and the like. These aspects may include, by way of example, and not by way of limitation:
1) Game Mechanics 602: the core rules of games that dictate how players enact change to achieve the necessary steps to progress, make or break games by acting as the foundation for gameplay. Mechanics are the main tool for building a desirable, fun activity for users. If they are faulty, little can be done to make a player enjoy their game-playing experience.
2) Interaction 604: the hardware and software elements between players and games, enables players to engage, interact and communicate. Good interaction often is intuitive and builds upon players' prior experience to facilitate meaning and action, and provides feedback conveying undeniable evidence that players' actions are understood.
3) Visual/Sensory Experience (aesthetics) 606: an important aspect of any game, as aesthetics have a profound impact on the engagement of the audience. Players enjoy interacting with pleasing and/or provocative sensory experience. A rich and engaging environment for the game, including its soundscape, is a key factor that determines whether players will continue to play, or to find something else to do.
4) Progression of games 608: temper the challenges to meet players' changing skill levels. Progression, often in the form of game levels, may be a key to ensure games are cast within the range of player skills. As players become more proficient in achieving established goals, game difficulty should increase to maintain interest. Progression plays a particularly key role in our framework. Its influence is two-fold, both to keep engagement, promoting treatment compliance, but also to grow appropriately as to promote maximal benefit in to mental fitness.

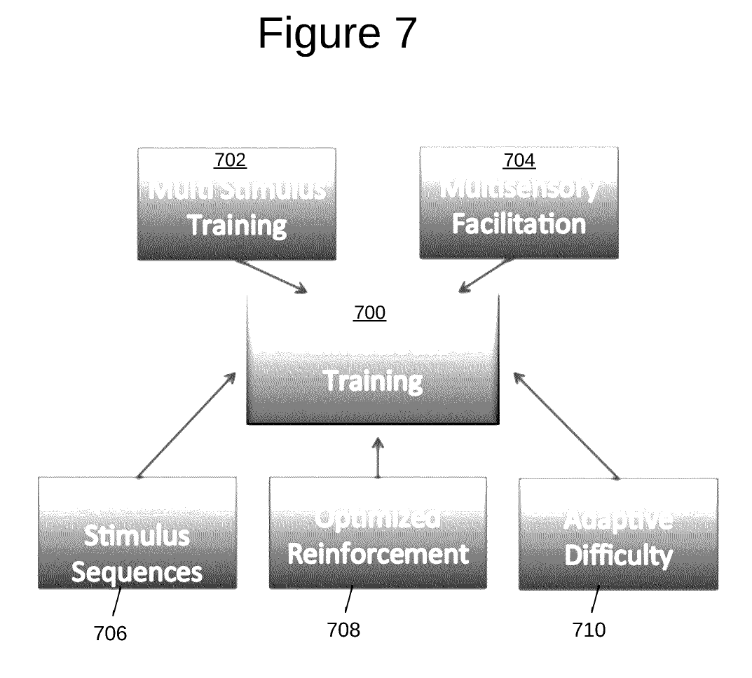

With reference to FIG. 7, there is shown a diagram providing view of some of the perceptual learning modules that can be combined to create more effective auditory training procedures. In describing some of the different types of learning modules that may be employed by game engine 202, for efficacious training 700, the game engine may employ one or more different learning modules of the type comprising: multi-stimulus training 702; multisensory facilitation 704; optimized sequences 706; optimized reinforcement 708; and adaptive difficulty 710.

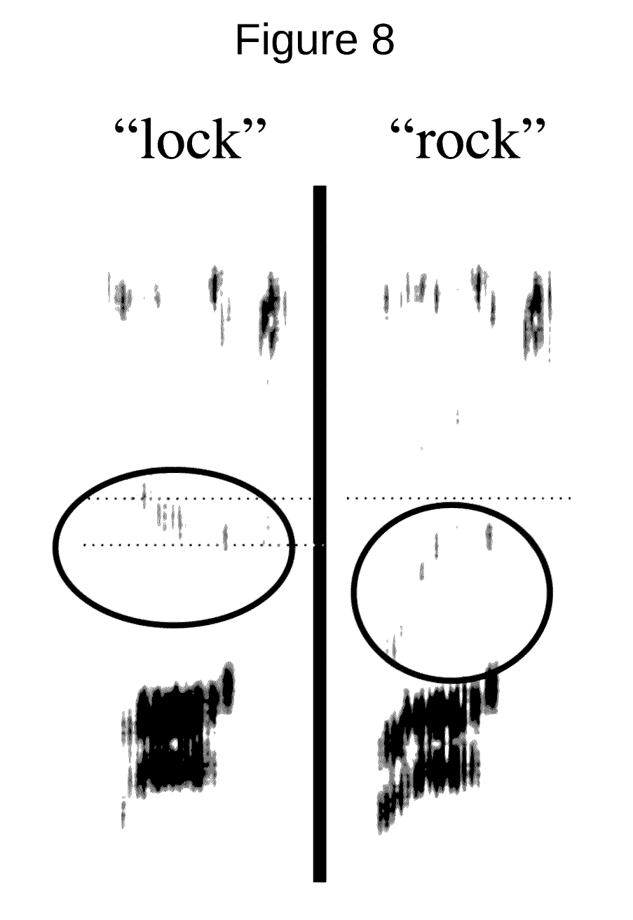

With reference to FIG. 8, a spectrogram (time vs frequency plot) of the words lock and rock is shown according to one embodiment. Five (5) distinct frequency bands can be visually discriminated, called formants. The third formant is circled and it is primarily in this formant that these two sounds differ. One embodiment includes training on isolated formant sounds and formant sounds embedded in other sound contexts from this and other words.

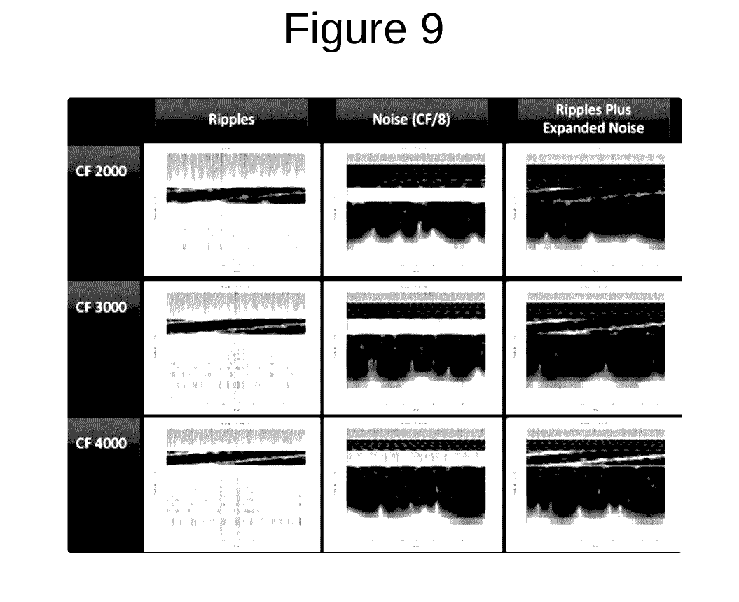

With reference to FIG. 9, a spectrogram (time vs frequency plot) of different narrow band ripples, notched-noise and ripples in noise, is shown according to one embodiment. Ripples have similar spectrograms of formants and can vary in many parameters (in FIG. 7, for convenience, only narrow band, one octave, ripples, are shown, but in the training procedures, in one embodiment, ripples of other bandwidths, frequencies, and vary other parameters of the stimuli widely are shown). These can also be combined with different types of noise (such as in this case notched noise which mimics conditions of sound discrimination in the speech where there is sound energy in many frequency bands).

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations wherein at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A system to enhance hearing, comprising:
a set of auditory stimuli that form a basis set of an auditory process that collectively span a relevant part of auditory feature space related to that process;
a game engine capable of running on a processor;
a first set of instructions executable on the processor comprising game mechanics;
a second set of instructions executable on the processor capable of providing interaction between a player and the game engine;
a third set of instructions executable on the processor capable of providing game aesthetics;
a fourth set of instructions executable on the processor for providing game progression; and
a fifth set of instructions executable on the processor for selecting one or more learning modules stored in a database, the one or more learning modules comprising auditory training procedures that are used within the game engine for auditory training of the player.

2. The system of claim 1, wherein the processor is on a local electronic device.

3. The system of claim 1, wherein the processor is on a server.

4. The system of claim 1, wherein the database is stored on a local electronic device.

5. The system of claim 1, wherein the database is stored on a server.

6. The system of claim 1, wherein the learning modules comprise hearing sensory training modules.

7. The system of claim 1, wherein the game mechanics further comprise core rules that dictate how the player enacts change to achieve game progress.

8. The system of claim 7, wherein the game engine is further capable of storing the game progress for the player in the database.

9. The system of claim 8, wherein the game engine is further capable of increasing difficulty of the game for the player according to the game progress.

10. The system of claim 1, wherein each learning module is of a type selected from the group consisting of: multi-stimulus training; multisensory facilitation; optimized sequences; optimized reinforcement; and adaptive difficulty.

11. A method to enhance hearing, comprising:
providing a set of auditory stimuli that form a basis set of an auditory process that collectively span a relevant part of auditory feature space related to that process;
running a game engine on a processor;
providing game mechanics for a game;
providing interaction between a player and the game engine;
providing game aesthetics;
providing game progression; and
selecting one or more learning modules stored in a database, the one or more learning modules comprising auditory training procedures that are used within the game engine for auditory training of the player.

12. The method of claim 11, wherein the processor is on a local electronic device.

13. The method of claim 11, wherein the processor is on a server.

14. The method of claim 11, wherein the database is stored on a local electronic device.

15. The method of claim 11, wherein the database is stored on a server.

16. The method of claim 11, wherein the learning modules comprise hearing sensory training modules.

17. The method of claim 11, wherein the game mechanics further comprise core rules that dictate how the player enacts change to achieve game progress.

18. The method of claim 17, comprising storing the game progress for the player in the database.

19. The method of claim 11, comprising increasing difficulty of the game for the player according to the game progress.

20. The method of claim 11, wherein each learning module is of a type selected from the group consisting of: multi-stimulus training; multisensory facilitation; optimized sequences; optimized reinforcement; and adaptive difficulty.
